(19) United States
(12) Patent Application Publication
(10) Pub. No.: US 2020/0193135 A1
(43) Pub. Date: Jun. 18, 2020

(54) IMAGE PROCESSING METHOD AND DEVICE, AND UNMANNED AERIAL VEHICLE

(71) Applicant: SZ DJI TECHNOLOGY CO., LTD., Shenzhen (CN)

(72) Inventors: Junping MA, Shenzhen (CN); Wei TUO, Shenzhen (CN); Qiang ZHANG, Shenzhen (CN); Zisheng CAO, Shenzhen (CN)

(21) Appl. No.: 16/797,607

(22) Filed: Feb. 21, 2020

Related U.S. Application Data
(63) Continuation of application No. PCT/CN2017/098810, filed on Aug. 24, 2017.

(51) Int. Cl. G06K 9/00; G06K 9/62; G06T 7/50; B64C 39/02

(52) U.S. Cl. CPC G06K 9/0063; G06K 9/6212; B64C 2201/127; B64C 39/024; G06T 7/50

(57) ABSTRACT

An image processing method is provided for an image device. The method includes obtaining type information of an image sensor of the image device; obtaining multi-path serial image signals outputted by the image sensor; converting the multi-path serial image signals into effective pixels according to the type information; and outputting the effective pixels.

### CROSS-REFERENCE TO RELATED APPLICATION

This application is a continuation of International Application No. PCT/CN2017/098810, filed Aug. 24, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of image processing technology and, more particularly, to a method and device for image processing, and an unmanned aerial vehicle (UAV).

### BACKGROUND

A digital imaging system, such as a digital camera, a digital video camera, or a medical imaging system, etc., is generally divided into two parts: an image sensor and an image processing device. The image sensor converts the brightness information into an electrical signal through an optical sensor and outputs the electrical signal to the image processing device. The image processing device receives electrical signals of an image outputted from the image sensor, performs image processing and compression, and then stores it at an external storage device.

There are many types of digital imaging systems. Some are suitable for high frame rates, some are suitable for high dynamic ranges, and some are suitable for high resolutions. Different types of digital imaging systems use different image sensors. An image processing device in a digital image system often can only be adapted to one corresponding image sensor. If the image sensor is replaced by another image sensor, it often means a new set of image processing devices needs to be developed, which greatly increases the hardware development cost.

### SUMMARY

In accordance with the disclosure, an image processing method for an image device includes obtaining type information of an image sensor of the image device; obtaining multi-path serial image signals outputted by the image sensor; converting the multi-path serial image signals into effective pixels according to the type information; and outputting the effective pixels.

Also in accordance with the disclosure, an image processing device includes an interface circuit and a processor. The processor is configured to obtain type information of an image sensor. The interface circuit is configured to obtain multi-path serial image signals outputted by the image sensor; convert the multi-path serial image signals into effective pixels according to the type information; and output the effective pixels.

### BRIEF DESCRIPTION OF THE DRAWINGS

FIG. 1 is a schematic flow chart of an image processing method according to an exemplary embodiment of the present invention;

FIG. 2 is a schematic diagram of two image sensors that output serial image signals according to another exemplary embodiment of the present invention;

FIG. 3 is a schematic flow chart of an image processing method according to another exemplary embodiment of the present invention;

FIG. 4 is a schematic diagram of serial image signals processed by time delay devices according to another exemplary embodiment of the present invention;

FIG. 5 is a schematic flow chart of an image processing method according to another exemplary embodiment of the present invention;

FIG. 6 is a schematic structural diagram of an image processing device according to another exemplary embodiment of the present invention;

FIG. 7 is a schematic structural diagram of an image processing device according to another exemplary embodiment of the present invention;

FIG. 8 is a schematic structural diagram of an image processing device according to another exemplary embodiment of the present invention;

FIG. 9 is a schematic structural diagram of an image processing device according to another exemplary embodiment of the present invention;

FIG. 10 is a schematic structural diagram of an image processing device according to another exemplary embodiment of the present invention; and

FIG. 11 is a schematic structural diagram of an unmanned aerial vehicle (UAV) according to another exemplary embodiment of the present invention.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Exemplary embodiments will be described with reference to the accompanying drawings, in which the same numbers refer to the same or similar elements unless otherwise specified. Features in various embodiments may be combined, when there is no conflict.

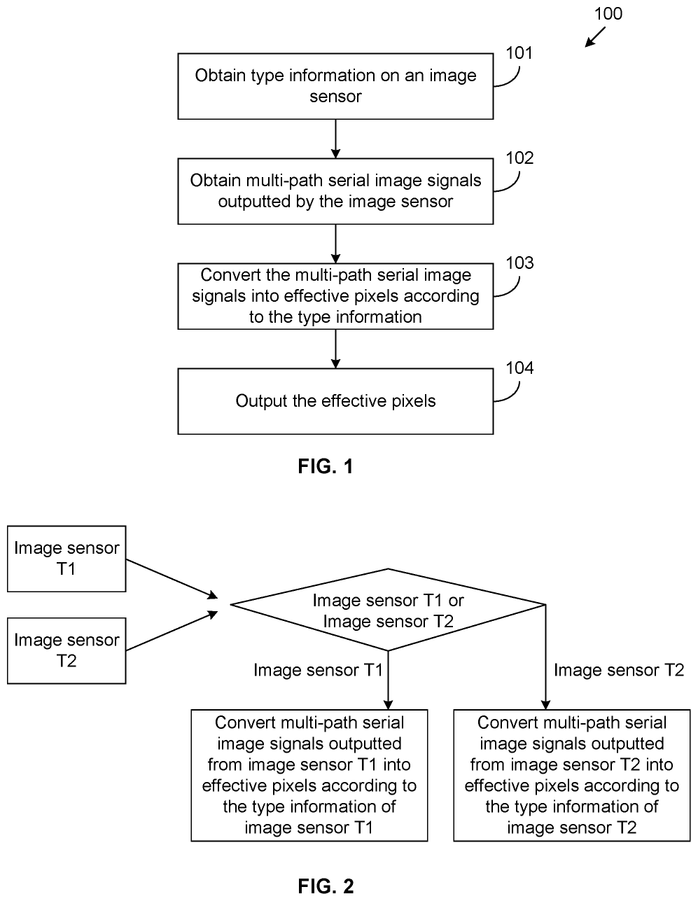

The present disclosure provides embodiments for image processing. FIG. 1 illustrates a schematic flow chart 100 of an exemplary image processing method consistent with the disclosure. As shown in FIG. 1, the exemplary method may include the followings.

At 101, the type information on an image sensor is obtained.

In embodiments of the present disclosure, there are multiple implementation methods for obtaining the type information of an image sensor. The following describes two implementation methods by way of example.

One implementation method is to communicate with an image sensor to obtain the type information about the image sensor. In one example, communicating with an image sensor to obtain the type information of an image sensor may specifically include sending a request message to the image sensor through a communication interface to request the type information of the image sensor, receiving a response message carrying the type information on the image sensor returned by the image sensor, and obtaining the type information on the image sensor from the received response message.

The other implementation method is to receive an external input instruction carrying image sensor type information, and obtain the image sensor type information from the received instruction. In an example, the instruction may be issued by a management platform or may be outputted by other devices, and embodiments of the present disclosure do not specifically limit any manners.

It should be noted that the above two implementation methods of obtaining the type information on an image sensor are only examples, and the methods do not limit the ways to obtain the type information on an image sensor.

In embodiments of the present disclosure, the type information on an image sensor acquired at 101 may include one or more of an identity ID, a type ID, a depth of pixel, and a transmission rule of serial image signals of the image sensor.

At 102, multi-path serial image signals outputted from the image sensor are obtained.

Under certain circumstances, the differences between different image sensors are mainly due to different numbers of high-speed paths, different operating frequencies, and different data formats. But a common feature among them is that serial image signals (e.g., image signals in series) are outputted through high-speed paths. The signals are also called high-speed serial image signals. Hence, once connected to an image sensor normally, it is easy to receive serial image signals (i.e., high-speed serial image signals) outputted by the image sensor through multiple high-speed paths. Then, the purpose of obtaining multi-path serial image signals outputted by the image sensor at 102 is achieved.

At 103, the multi-path serial image signals are converted into effective pixels according to the type information on the image sensor.

FIG. 2 illustrates a schematic diagram of two image sensors that outputs multi-path serial image signals consistent with the disclosure. As shown in FIG. 2, if signals obtained at 102 are multi-path serial image signals outputted by an image sensor T1, when the process proceeds to 103, the multi-path serial image signals outputted by the image sensor T1 may be converted into effective pixels according to the type information on the image sensor T1. Then, if the image sensor T1 is replaced with an image sensor T2, the signals obtained at 102 are multi-path serial image signals outputted by the image sensor T2. When the process proceeds to 103, the multi-path serial image signals outputted by the image sensor T2 may be converted into effective pixels according to the type information on the image sensor T2.

At 104, the effective pixels are outputted.

Hence, for embodiments of the present disclosure, during image processing, multi-path serial image signals outputted by an image sensor are converted into effective pixels according to the type information of the image sensor. When a different image sensor is used, multi-path image signals outputted by the different image sensor may be processed according to different type information. As such, image processing is no longer limited to a specific image sensor and instead, is designed to support different image sensors respectively.

In some embodiments of the present disclosure, for a digital imaging system, a set of image processing algorithms corresponding to flow chart 100 in FIG. 1 may be developed. The set of image processing algorithms may serve different image sensors. When an image sensor of one type is replaced by an image sensor of another type at the digital imaging system, there is no need to develop new algorithms, which may save hardware and software costs.

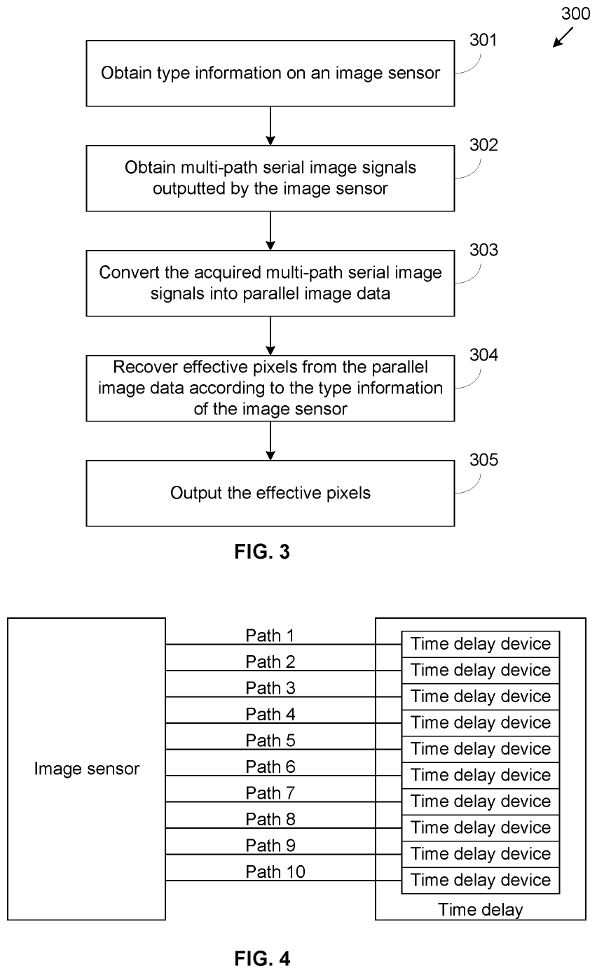

FIG. 3 illustrates a schematic flow chart 300 of another exemplary method for image processing consistent with the disclosure. As shown in FIG. 3, the exemplary method may include the following steps or processes.

At 301, the type information on an image sensor is obtained. Process 301 is similar to process 101 described in FIG. 1, and details are omitted here.

At 302, multi-path serial image signals outputted from the image sensor are obtained. Process 302 is similar to process 102 described in FIG. 1, and details are omitted here.

At 303, the acquired multi-path serial image signals are converted into parallel image data. Process 303 and the following process 304 reflect some implementations for process 103 shown in FIG. 1, where multiple serial image signals are converted into effective pixels according to the type information about the image sensor.

When the acquired multi-path serial image signals are converted into parallel image data at 303, a serial-to-parallel method may be used. For example, each time a serial image signal of a path is received, the signal may be temporarily buffered, such as buffered in a counter, etc. After serial image signals of all paths are received, parallel image data may be obtained by outputting through a shift operation. Converting multi-path serial image signals into parallel image data may improve the data transmission efficiency.

In some embodiments, in order to ensure that the acquired multi-path serial image signals are stable and correct, time delay of serial image signals of each path may be adjusted before converting the acquired serial image signals into parallel image data at 303.

Based on that different image sensors require different delay times, in regard to the serial image signals of each path, the above-mentioned adjustment of time delay may be performed according to the type information on the image sensor obtained at 301.

Specifically, adjustment of time delay for serial image signals of each path may include inserting a time delay device in each path, and controlling the inserted time delay device to adjust the delay of serial image signals of each path according to the type information on an image sensor. FIG. 4 illustrates a schematic diagram of multi-path serial image signals processed by time delay devices consistent with the disclosure. As shown in FIG. 4, if an image sensor outputs serial image signals through 10 paths, a time delay device may be inserted in each path. There are many ways to implement time delay such as simple logic gates such as Not-AND (NAND) gates, first-in, first-out (FIFO) or random access memory (RAM), negative clock driving D flip-flop (DFF), suitable buffers, shift registers, etc.

At 304, effective pixels are recovered from the parallel image data according to the type information on the image sensor.

Different types of image sensors may have different ways of outputting serial image signals. Different ways of outputting serial image signals require different methods to recover effective pixels. At 304, a method to recover effective pixels may be determined according to the type information on the image sensor, and then the effective pixels are recovered from the parallel image data using the determined method. Hence, effective pixels may be recovered from multi-path serial image signals according to the type information of an image sensor. When a different image sensor is used, multi-path image signals outputted by the different image sensor may be processed according to different type information. As such, image processing is no longer limited to a fixed image sensor and may support different image sensors respectively.

Different types of image sensors may need different pixel depths. In order to ensure that effective pixels that are finally recovered match the pixel depth required by a currently connected image sensor, the following steps or processes may be performed.

As mentioned at 304, effective pixels may be recovered from parallel image data according to the type information on an image sensor in a recovery process. The recovery process may include determining the depth of effective pixel of an image sensor according to the type information; and recovering effective pixels from the parallel image data according to the depth of effective pixel. For example, if the depth of effective pixel as required by an image sensor is 24 bits, recovering effective pixels from the parallel image data according to the depth of effective pixel may include recovering effective pixels based on the principle that the depth of effective pixel is 24 bits, where each effective pixel that is finally recovered is 24 bits.

Serial image signals of each path outputted by an image sensor carry a synchronization character or symbol corresponding to the image sensor. The synchronization character includes at least one of a start synchronization character or an end synchronization character. Different image sensors have different start sync characters and different end sync characters. Accordingly, in some embodiments of the present disclosure, recovering effective pixels from parallel image data according to the type information at 304 may include determining synchronization characters corresponding to an image sensor according to the type information on the image sensor; searching for the synchronization characters in the parallel image data; and recovering effective pixels from the parallel image data according to the searched synchronization characters.

Taking searched synchronization words including start synchronization characters as an example. If the depth of effective pixel of a determined image sensor is 24 bit, the first start synchronization character is searched from the parallel image data, and characters immediately following the first starting synchronization character are organized to form a pixel according to the principle of the 24 bit depth. When a second start synchronization character is searched, each character immediately following the searched second start synchronization character are organized to form a pixel according to the principle of the 24 bit depth, and so on, and finally all effective pixels are recovered from the parallel image data according to the searched synchronization characters.

In some embodiments of the present disclosure, recovering effective pixels from parallel image data according to the type information at 304 may include determining the depth of effective pixel of the image sensor and the synchronization characters of the image sensor corresponding to the type information, and recovering effective pixels from parallel image data according to the determined depth of effective pixel and the synchronization characters of the image sensor. In the following, synchronization characters including a start and an end synchronization character corresponding to an image sensor are used as an example. The example describes how to recover effective pixels from parallel image data according to a determined depth of effective pixel and synchronization characters of an image sensor.

In one scenario, the number of characters between a pair of start synchronization character and an end synchronization character is exactly an integer multiple of the depth of effective pixel of an image sensor. For example, assuming the depth of effective pixel of a determined image sensor is 24 bits, and the number of characters between a pair of start and end characters is 240. The start synchronization character may be searched from the parallel image data (e.g., searching for the first start synchronization character), the first 24 characters immediately following the searched first start synchronization character may be organized into a pixel, and so on, and finally, the 240 characters between the first start synchronization character and the first end synchronization character may be organized into 10 pixels.

In another scenario, the number of characters between a pair of start synchronization character and end synchronization character is not an integer multiple of the depth of effective pixel of an image sensor. For example, assuming the depth of effective pixel of a determined image sensor is 24 bits, and the number of characters between a pair of start and end characters is 100. The start synchronization character may be searched from the parallel image data (e.g., searching for the first start synchronization character), the first 24 characters immediately following the searched first start synchronization character may be organized into a pixel, and so on, and finally, there are 4 characters left in the end. At this time, the remaining 4 characters may be organized into a pixel along with 20 characters that follow the second start synchronization character, and so on.

At 305, the effective pixels are outputted. Process 305 is similar to process 104 described in FIG. 1, and details are omitted here.

In some embodiments of the present disclosure, when image processing is performed, time delay of serial image signals of each path is adjusted according to the type information of an image sensor to ensure stable reception of serial image signals of each path, then the received multi-path serial image signals are converted into parallel image data to improve the efficiency of subsequent data output, and finally, the effective pixels are recovered from the parallel image data according to the type information of the image sensor, the synchronization characters of the image sensor, and the depth of effective pixel of the image sensor. As such, multi-path serial image signals outputted by different image sensors may be converted into effective pixels using different procedures. It may make an image processing solution support multiple image sensors, instead of a fixed image sensor.

In some embodiments of the present disclosure, for a digital imaging system, a set of image processing algorithms corresponding to flow chart 300 in FIG. 3 may be developed. The set of image processing algorithms may work with different image sensors. When an image sensor of one type is replaced by an image sensor of another type at the digital imaging system, there is no need to develop new algorithms, thereby saving hardware and software costs.

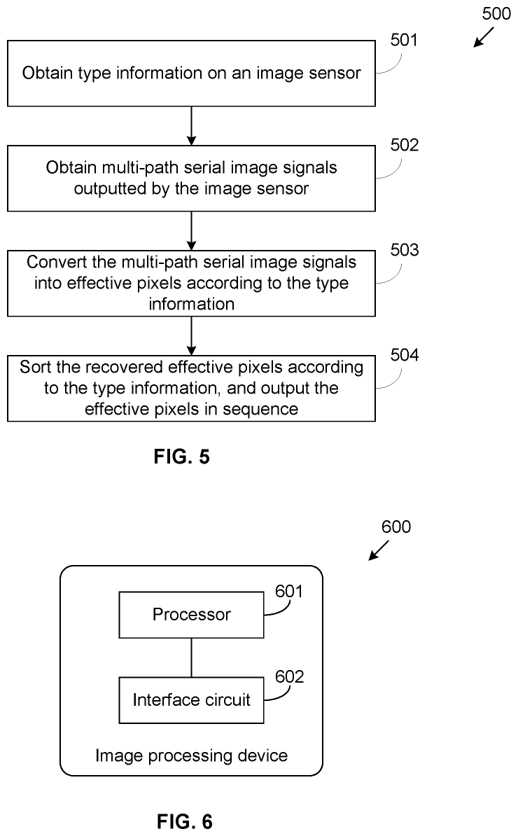

FIG. 5 illustrates a schematic flow chart 500 of another exemplary image processing method consistent with the disclosure. As shown in FIG. 5, the exemplary method may include the following processes or steps.

At 501, the type information of an image sensor is obtained. Process 501 is similar to process 101 described in FIG. 1, and details are omitted here.

At 502, multi-path serial image signals outputted from the image sensor are obtained. Process 502 is similar to process 102 described in FIG. 1, and details are omitted here.

At 503, the multi-path serial image signals are converted into effective pixels according to the type information. Process 503 is similar to process 103 described in FIG. 1, and details are omitted here.

At 504, the recovered effective pixels are sorted according to the type information, and the effective pixels are outputted in sequence.

As different types of image sensors may have different methods of outputting serial image signals, methods of recovering effective pixels are different, and the sequence of effective pixels finally recovered may also be different. The sequence of effective pixels here may refer to the storage sequence of the recovered pixels in a storage unit such as a memory, a buffer, etc.

Accordingly, before effective pixels are outputted at 504, the recovered effective pixels need to be sorted according to the type information to ensure that the effective pixels are outputted in sequence finally and further in a sequence required by an image processing circuit, that is, to ensure that the output sequence of effective pixels matches an input order required by the image processing circuit.

Specifically, at 504, sorting the recovered effective pixels according to the type information may include determining a mode of sorting effective pixels corresponding to the image sensor according to the type information on the image sensor; and according to the determined sorting mode, sorting recovered effective pixels to ensure that the sorted pixels may be outputted in sequence.

In some embodiments of the present disclosure, a sorting method of effective pixels corresponding to an image sensor may be related to a transmission rule of serial image signals of the image sensor. Accordingly, for some embodiments, sorting recovered effective pixels according to the type information at 504 may include determining a transmission rule of serial image signals of the image sensor according to the type information; and sorting the recovered effective pixels according to the transmission rule.

Different image sensors may have different transmission rules for serial image signals. A transmission rule may specifically include the number of data paths for output of serial image signals and how a pixel arrangement order of an image sensor is configured. For example, the depth of effective pixel of a determined image sensor is 24 bit and the image sensor has 24 data paths to output serial image signals. A pixel arrangement order of the image sensor may be that 24 characters of the same pixel are outputted via the same data path. In this way, effective pixels recovered from the serial image signals of each data path may be sequentially arranged and outputted in accordance with the order of the data path.

In some embodiments of the present disclosure, when image output is performed, effective pixels recovered may be sorted according to the type information of an image sensor, and the effective pixels are outputted in sequence. As such, multi-path serial image signals outputted by different image sensors may be converted into effective pixels according to the type information and the effective pixels are then sorted and outputted in sequence. It may make an image processing solution suitable to support multiple image sensors, instead of a fixed image sensor.

In some embodiments of the present disclosure, for a digital imaging system, a set of image processing algorithms corresponding to flow chart 500 in FIG. 5 may be developed. The set of image processing algorithms may support different image sensors. When an image sensor of one type is replaced by an image sensor of another type at the digital imaging system, there is no need to develop new algorithms, and thus hardware and software costs may be reduced.

Based on the embodiments shown in FIGS. 1, 3, and 5, the methods in these embodiments may further include determining a driver (e.g., a driving program for the image process device) to be run according to the type information of the image sensor; and running the driver to control the image sensor.

There are many ways to determine a driver to be run based on the type information of an image sensor. For example, drivers of different image sensors may be pre-installed. When the type information on a currently connected image sensor is obtained as described at 101 in FIG. 1, determining a driver that needs to be run according to the type information may include finding a driver corresponding to the type information on the image sensor from different pre-installed drivers. For example, three drivers are pre-installed for three sensors 1A, 1B, and 1C. The type information on the currently connected image sensor may be obtained as shown at 101 in FIG. 1. If the type information about the sensor 1A is determined, the driver of 1A may be found from the pre-installed drivers to control the sensor 1A.

Based on the embodiments shown in FIGS. 1, 3, and 5, the methods in these embodiments may further include performing preset processing on the received effective pixels. The preset processing here may be performed mainly according to image processing algorithms that are set based on demand. In some embodiments, the image processing algorithms may be one or more of dead pixel removal, white balance, gamma correction, and automatic exposure.

Based on the embodiments shown in FIGS. 1, 3, and 5, the methods in these embodiments may further include encoding effective pixels after the preset processing. After that, the encoded video stream may be stored at an external storage device. In some embodiments, an external storage device may be one of secure digital (SD) card or CompactFlash (CF) card.

Image processing methods provided by embodiments of the present disclosure have been described above. In some embodiments of the present disclosure, the processes shown in FIGS. 1, 3, and 5 may be implemented on the premise of compatibility with multiple image sensors using field-programmable gate array (FPGA), as different programming files may be written to FPGA based on the programmability of FPGA. For example, when image sensor A is used, a set of image sensor A firmware may be programmed in the FPGA to implement the processes shown in FIGS. 1, 3, and 5. When image sensor B is used, a set of image sensor B firmware may be programmed in the FPGA to implement the processes shown in FIGS. 1, 3, and 5. Hence, different types of image sensors may be supported.

An image processing device provided by some embodiments of the present disclosure is described below. In some embodiments, an image processing device may be separated from an image sensor. In some other embodiments, an image processing device may be an application-specific chip or a programmable device. In some embodiments, an application-specific chip may be an application-specific integrated circuit (ASIC) chip and a programmable device may be a field programmable gate array (FPGA) or a complex programmable logic device (CPLD).

FIGS. 6-10 schematically show structural block diagrams of an image processing device 600 consistent with the present disclosure. As shown in FIG. 6, the image processing device 600 may include a processor 601 and an interface circuit 602.

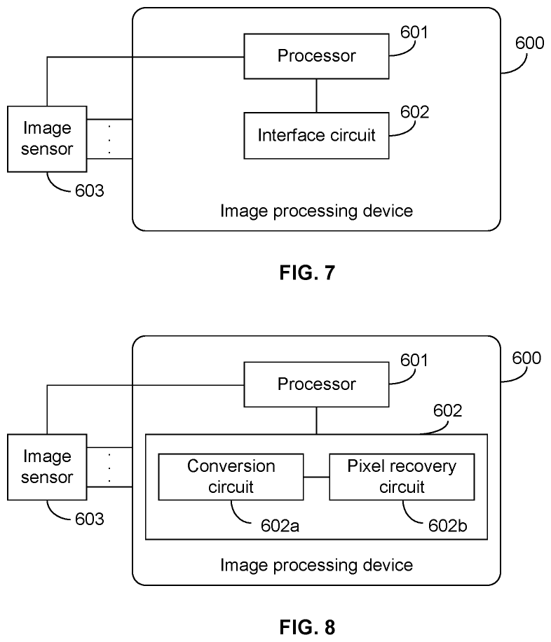

The image processing device 600 shown in FIG. 6 interacts with an external image sensor (denoted as 603 in FIGS. 7-10), and for example, FIG. 7 shows a schematic diagram of the interaction.

In some embodiments of the present disclosure, the processor 601 is configured to obtain type information on the image sensor 603.

In some embodiments of the present disclosure, the type information about the image sensor 603 acquired by the processor 601 includes one or more of an identity ID, a type ID, a pixel depth, and a transmission rule of serial image signals of the image sensor 603.

When the processor 601 obtains the type information on the image sensor 603, it may inform the interface circuit 602. The interface circuit 602 may be configured to obtain multi-path serial image signals outputted by the image sensor 603; convert the multi-path serial image signals into effective pixels according to the type information; and output the effective pixels.

In some embodiments of the present disclosure, during image processing, multi-path serial image signals outputted by an image sensor may be converted into effective pixels according to the type information of the image sensor, instead of converting the signals in a current fixed manner. Thus, the effective pixels converted from multi-path image signals outputted by different image sensors may eventually match corresponding image sensors respectively and correctly. It may make one image processing solution applicable to different image sensors, instead of a fixed image sensor.

In some embodiments of the present disclosure, for a digital imaging system, a set of image processing algorithms corresponding to the imaging processing device 600 shown in FIG. 6 may be developed. The set of image processing algorithms may support different image sensors. When an image sensor of one type is replaced by an image sensor of another type at the digital imaging system, there is no need to develop new algorithms, thereby saving hardware and software costs.

Based on the technical solution provided by the embodiment shown in FIG. 6, the interface circuit 602 may include a conversion circuit 602a and a pixel recovery circuit 602b, as shown schematically in FIG. 8.

The conversion circuit 602a may be configured to convert multi-path serial image signals into parallel image data. The pixel recovery circuit 602b may be configured to recover the effective pixels from the parallel image data according to the type information.

In some embodiments, the conversion circuit 602a may be further configured to adjust time delay of serial image signals of each path according to the type information before converting the multi-path serial image signals into parallel image data.

In some embodiments, the pixel recovery circuit 602b may be specifically configured to determine the depth of effective pixel of the image sensor according to the type information; and recover effective pixels from the parallel image data according to the depth of effective pixel.

In some embodiments, the pixel recovery circuit 602b may be specifically configured to determine synchronization characters of an image sensor according to the type information; search for synchronization characters in parallel image data; and recover effective pixels from the parallel image data according to the searched synchronization characters. In some embodiments, the synchronization character may include at least one of a start synchronization character or an end synchronization character.

In some embodiments of the present disclosure, when image processing is performed, time delay of serial image signals of each path is adjusted according to the type information of an image sensor to ensure stable reception of serial image signals of each path, then the received multi-path serial image signals are converted into parallel image data to improve the efficiency of subsequent data output, and finally, effective pixels are recovered from the parallel image data according to the type information of the image sensor, the synchronization characters of the image sensor, and the depth of effective pixel of the image sensor. As such, multi-path serial image signals outputted by different image sensors may be converted into effective pixels using different methods based on the type information, instead of being processed in the current fixed way. Hence, one image processing solution may be applicable to different image sensors.

In some applications of embodiments of the present disclosure, for a digital imaging system, a set of image processing algorithms corresponding to flow chart 500 in FIG. 5 or one of the embodiments shown in FIGS. 6-8 may be developed. The set of image processing algorithms may support different image sensors. When an image sensor of one type is replaced by an image sensor of another type at the digital imaging system, there is no need to develop new algorithms, thereby saving hardware and software costs.

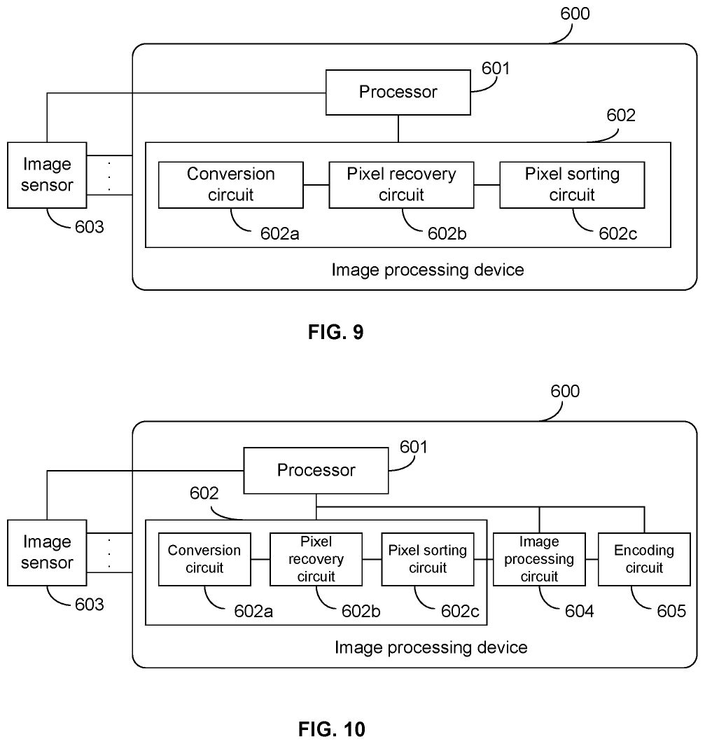

Based on the technical solution provided by the embodiment shown in FIG. 6, the interface circuit 602 may further include a pixel sorting circuit 602c, as shown schematically in FIG. 9.

The pixel sorting circuit 602c may be configured to sort the recovered effective pixels according to the type information and output the effective pixels in sequence. In some embodiments, the pixel sorting circuit 602c may be specifically configured to determine a transmission rule of serial image signals of the image sensor according to the type information; and sort the recovered effective pixels according to the transmission rule.

In some embodiments of the present disclosure, when image outputting is performed, the effective pixels recovered are sorted according to the type information of an image sensor, and the effective pixels are outputted in sequence. As such, multi-path serial image signals outputted by different image sensors may be converted into effective pixels according to respective type information and the effective pixels are then sorted and outputted in sequence. Hence, one image processing solution may support different image sensors.

Based on the technical solution provided by the embodiment shown in FIG. 6, the image processing device 600 may further include an image processing circuit 604 and an encoding circuit 605, as shown in FIG. 10. The image processing circuit 604 may be configured to perform preset processing on the received effective pixels. In some embodiments, the preset processing may include one or more of dead pixel removal, white balance, and gamma correction.

The encoding circuit 605 may be configured to encode the effective pixels after the preset processing is performed.

Based on the technical solution provided by the embodiment shown in FIG. 6, the processor 601 may be further configured to determine a driver to be run according to the type information; and run the driver to control the image sensor.

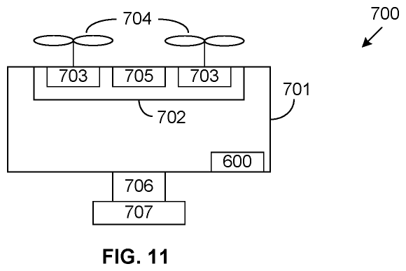

Some embodiments of the present invention may provide an unmanned aerial vehicle (UAV). FIG. 11 schematically shows a structural block diagram of a UAV 700 consistent with the present disclosure. UAV 700 may include a fuselage 701, a power system 702, and an image processing device 600 that is described above.

The power system 702 is installed in the fuselage for providing flight power and may include at least one of a motor 703, a propeller 704, and an electronic speed regulator 705.

The principles and implementations of the image processing device 600 are same as or similar to those of the above embodiments, and are not repeated here.

In addition, as shown in FIG. 11, the UAV 700 may further include a supporting device 706 and a photographing device 707. The supporting device 706 may be a gimbal, the photographing device 707 may be a camera, and the camera may include an image sensor.

In some embodiments of the present disclosure, during image processing, multi-path serial image signals outputted by an image sensor may be converted into effective pixels according to the type information of the image sensor, instead of converting the signals in a current fixed manner. Thus, the effective pixels converted from multi-path image signals outputted by different image sensors may eventually match corresponding image sensors respectively and correctly. It may make one image processing solution support different image sensors, instead of serving a fixed image sensor.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The integrated unit may be implemented in the form of hardware. The integrated unit may also be implemented in the form of hardware plus software functional units.

The integrated unit implemented in the form of software functional unit may be stored in a non-transitory computer-readable storage medium. The software functional units may be stored in a storage medium. The software functional units may include instructions that enable a computer device, such as a personal computer, a server, or a network device, or a processor to perform part of a method consistent with embodiments of the disclosure, such as each of the exemplary methods described above. The storage medium may include any medium that can store program codes, for example, a USB disk, a mobile hard disk, a read-only memory (ROM), a random access memory (RAM), a magnetic disk, or an optical disk.

People skilled in the art may understand that for convenient and concise descriptions, above examples and illustrations are based only on the functional modules. In practical applications, the functions may be distributed to and implemented by different functional modules according to the need. That is, the internal structure of a device may be divided into different functional modules to implement all or partial functions described above. The specific operational process of a device described above may refer to the corresponding process in the embodiments described above, and no further details are illustrated herein.

Further, it should be noted that the above embodiments are used only to illustrate the technical solutions of the present disclosure and not to limit it to the present disclosure. Although the present disclosure is described in detail in the light of the foregoing embodiments, those of ordinary skill in the art should understand that they can still modify the technical solutions recorded in the preceding embodiments, or they can perform equivalent replacements for some or all of the technical features. The modifications or substitutions, however, do not make the nature of the corresponding technical solutions out of the scope of the technical solutions of each embodiment of the present disclosure.

What is claimed is:

1. An image processing method for an image device, comprising:
obtaining type information of an image sensor of the image device;
obtaining multi-path serial image signals outputted by the image sensor;
converting the multi-path serial image signals into effective pixels according to the type information; and
outputting the effective pixels.

2. The method according to claim 1, wherein converting the multi-path serial image signals into the effective pixels according to the information includes:
converting the multi-path serial image signals into parallel image data; and
recovering effective pixels from the parallel image data according to the type information.

3. The method according to claim 2, further comprising:
adjusting time delay of the multi-path serial image signals of each path before converting the multi-path serial image signals into the parallel image data.

4. The method according to claim 2, wherein recovering the effective pixels from the parallel image data according to the information includes:
determining a depth of effective pixel of the image sensor according to the information; and
recovering the effective pixels from the parallel image data according to the depth of effective pixel.

5. The method according to claim 2, wherein recovering the effective pixels from the parallel image data according to the information includes:
determining a synchronization character of the image sensor according to the information;
searching for the synchronization character in the parallel image data; and
recovering the effective pixels from the parallel image data according to the synchronization character.

6. The method according to claim 5, wherein the synchronization character includes at least one of a start synchronization character and an end synchronization character.

7. The method according to claim 1, wherein outputting the effective pixels includes:
sorting the effective pixels according to the type information; and
outputting the effective pixels in sequence.

8. The method according to claim 7, wherein sorting the effective pixels according to the type information includes:
determining a transmission rule of serial image signals of the image sensor according to the type information; and
sorting the effective pixels according to the transmission rule.

9. The method according to claim 8, further comprising:
determining a driver to be run according to the type information; and
running the driver to control the image sensor.

10. The method according to claim 1, further comprising:
performing preset processing on the effective pixels.

11. The method according to claim 10, wherein the preset processing includes one or more of dead pixel removal, white balance, and gamma correction.

12. The method according to claim 11, further comprising:
encoding the effective pixels after the preset processing.

13. The method according to claim 1, wherein the type information includes one or more of an identity ID, a type ID, a pixel depth, and a transmission rule of serial image signals of the image sensor.

14. An image processing device, comprising:
an interface circuit; and
a processor,
wherein the processor is configured to obtain type information on an image sensor, the interface circuit is configured to:
obtain multi-path serial image signals outputted by the image sensor;
convert the multi-path serial image signals into effective pixels according to the type information; and
output the effective pixels.

15. The device according to claim 14, wherein the interface circuit includes a conversion circuit and a pixel recovery circuit, the conversion circuit is configured to convert the multi-path serial image signals into parallel image data, the pixel recovery circuit is configured to recover the effective pixels from the parallel image data according to the type information.

16. The device according to claim 15, wherein the conversion circuit is further configured to adjust time delay of multi-path serial image signals of each path according to the type information before converting the multi-path serial image signals into the parallel image data.

17. The device according to claim 15, wherein the pixel recovery circuit is configured to:
determine a depth of effective pixel of the image sensor according to the type information; and
recover the effective pixels from the parallel image data according to the depth of effective pixel.

18. The device according to claim 17, wherein the pixel recovery circuit is further configured to:
determine a synchronization character of the image sensor according to the type information;
search for the synchronization character in the parallel image data; and
recover the effective pixels from the parallel image data according to the synchronization character.

19. The device according to claim 14, wherein the interface circuit further includes a pixel sorting circuit configured to sort the effective pixels according to the type information and output the effective pixels in sequence.

20. The device according to claim 19, wherein the pixel sorting circuit is configured to:
determine a transmission rule of serial image signals of the image sensor according to the type information; and
sort the effective pixels according to the transmission rule.
